(19) United States
(12) Patent Application Publication
(10) Pub. No.: US 2017/0032403 A1
(43) Pub. Date: Feb. 2, 2017

(54) Method of Certifying and Distributing Patterns

(71) Applicant: Elizabeth Caven, Des Moines, IA (US)

(72) Inventor: Elizabeth Caven, Des Moines, IA (US)

(21) Appl. No.: 14/812,826

(22) Filed: Jul. 29, 2015

(51) Int. Cl. G06Q 30/02; G06Q 30/06

(52) U.S. Cl. CPC G06Q 30/0214; G06Q 30/0601

(57) ABSTRACT

A method for allowing on-line and physical retailers to simultaneously benefit from a single sale is presented. At its most basic form the method comprises compensating physical retail stores for driving on-line sales for an on-line store. The method comprises the provision of a code and/or URL by a physical retail store to its customers. The code and/or URL is associated with an on-line store and, when the customer employs the code and/or URL when making a purchase from the on-line retailer, the physical retailer is paid a commission or other form of compensation. Alternatively, an on-line retailer may provide to a purchaser a code that may be redeemed at a physical retailer.

### BACKGROUND

Retail sales have been the bedrock of many commercial efforts for decades if not longer. In short, a retailer is typically the seller that offers a good or product to the final purchaser. Although not always, most retail sellers offer a number of different products, and typically those products are from different sources. In modern day, a retail store might be a boutique offering to purchasers a specialized group of goods that the retailer purchased from a wholesaler or from the source or, alternatively, a retailer can be a large department store, for example, offering to the purchaser dozens of different goods from dozens of sources. Recently, retail or wholesale sales may also be accomplished through on-line shopping. On-line shopping typically includes means for a shopper to browse the goods offered through a particular website, obtain information regarding the goods or services in which he is interested, and then use a means to purchase the selection. Means to purchase may comprise any one of several programmed tools that facilitate the shopper's selection, ordering, payment for, and even delivery of the selected item. On-line retailers or providers may target consumers based on past on-line buying habits, demographics, or other selectors.

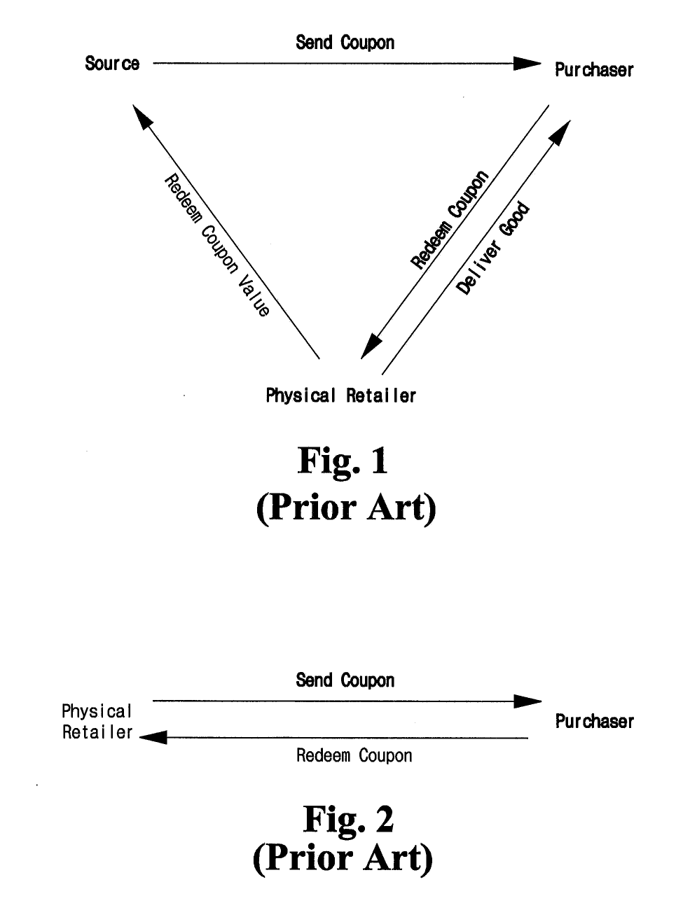

In order to compete, retailers often adjust a price on a given item to entice new customers or to retain repeat customers. Similarly, the source of a particular good may wish to temporarily lower the price of that good in order to entice new purchasers or to build loyalty of prior purchasers. One of the methods employed by the retailer or the source is to issue coupons which are redeemable by the purchaser. (See FIG. 1). For years coupon distribution has been done through periodic publications such as newspapers or through the mail via targeted mailing lists. On-line retailers may provide electronic coupons to be used through that on-line retailer's purchasing site or at other sites where the product or service may be purchased. (See FIG. 2) Alternatively, coupons may be obtained online at sites such as coupons.com where the consumer may print a manufacturer's coupon and take it along to the retailer and redeem it.

The traditional patterns for coupon use comprises issuance of a coupon to a purchaser who, upon purchase, redeems the value of the coupon. The source of the good to be purchased and the source of the coupon are the same. The source provides the coupon to the consumer. The consumer then purchases the good from one of two providers; from the source or from the retailer. The consumer submits the coupon to the provider and the provider discounts the price (or performs or facilitates the other benefits for which the coupon is meant). If the provider and source are the same entity, the process is finished. If the provider is simply a retailer, then the provider/retailer will submit the redeemed coupon to the source and the source will compensate the retailer for the discount See FIGS. 1 and 2.

The present invention provides a novel process which allows an online retailer and a physical retailer to cooperate in ways that are financially beneficial to both parties, through the same consumers, preferably relative to purchases of related products.

### SUMMARY OF THE INVENTION

The present invention changes up the traditional coupon redemption scheme to allow cooperation and mutual benefit between an on-line source and/or a physical retailer. In this method the on-line source assigns and provides a unique code or URL or a code in which a unique URL is imbedded to the retailer. The retailer then provides that unique code or URL to a purchaser. The purchaser then purchases something from the online source using the unique code or URL, Using the unique code or URL may or may not provide a discount or other benefit to the purchaser. The online source then applies a compensation factor, determines a compensation amount in accordance with the unique code or URL, and compensates the retailer accordingly. In this way, the on-line source incents the retailer to drive sales to the on-line source.

### DETAILED DESCRIPTION OF DRAWINGS

FIG. 1 Prior Art means by which purchaser redeems or is provided a discount;

FIG. 2 Second Prior Art means by which purchaser redeems or is provided a discount;

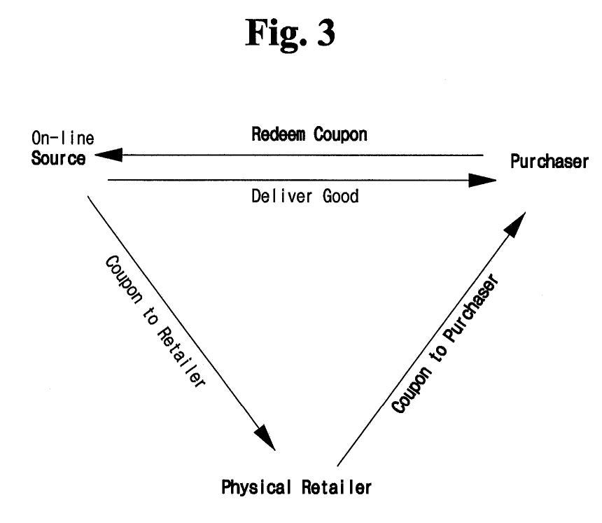

FIG. 3 Computer-facilitated means for online source to compensate a physical retailer for an on-line sale;

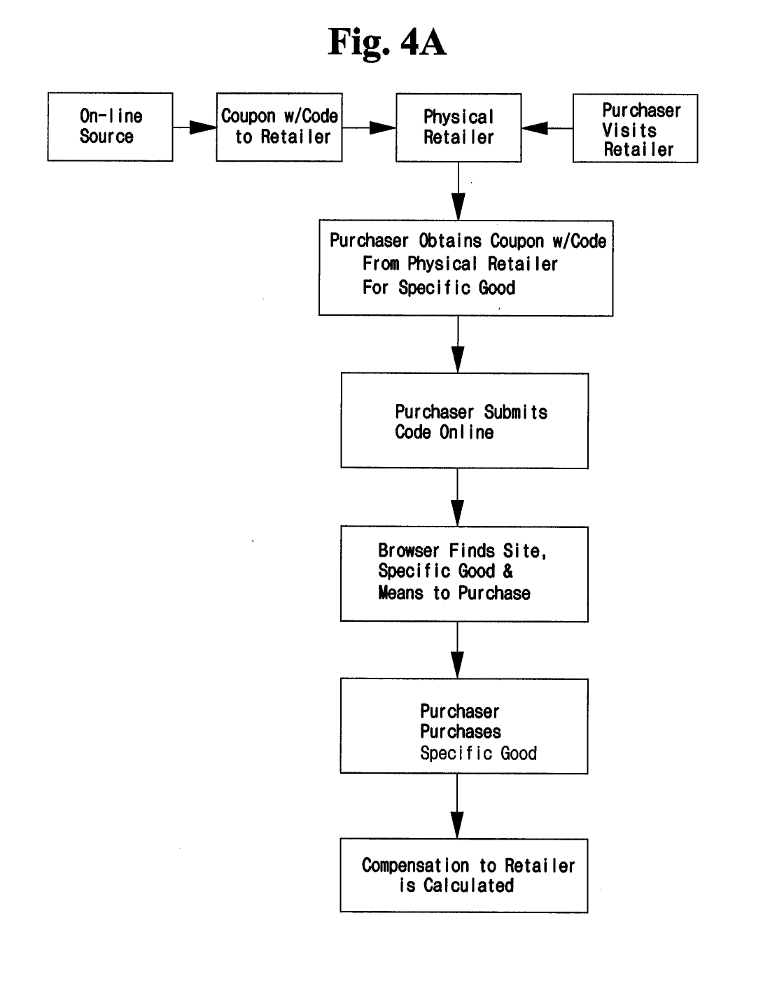

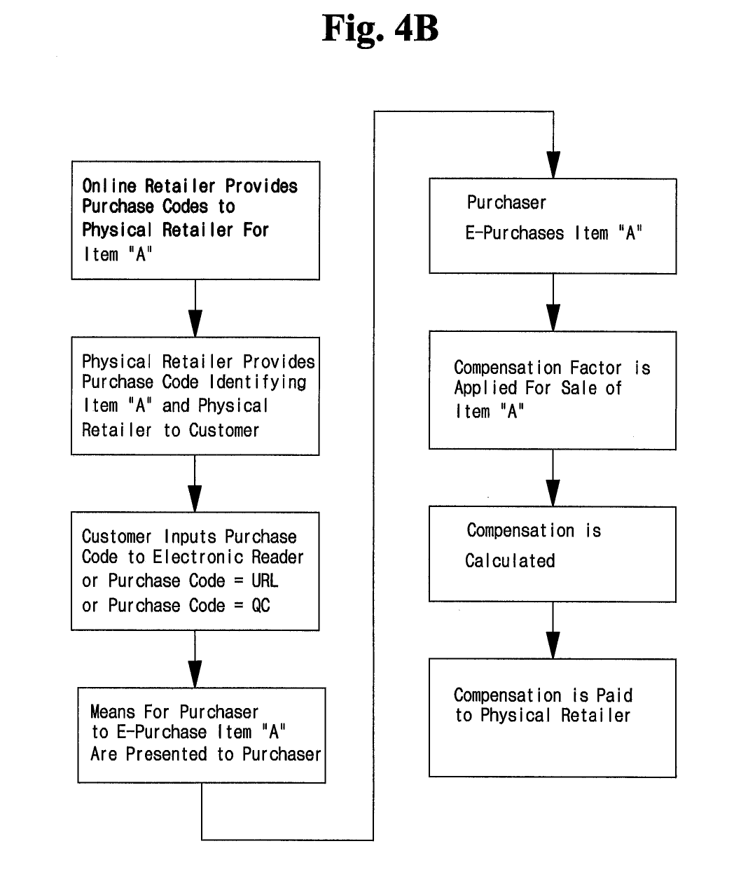

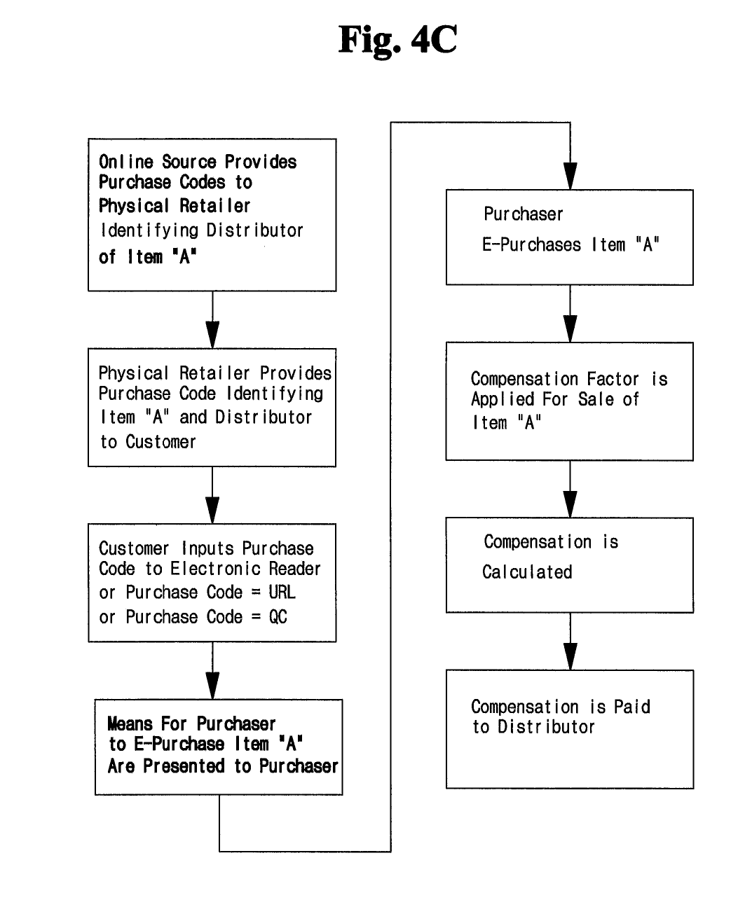

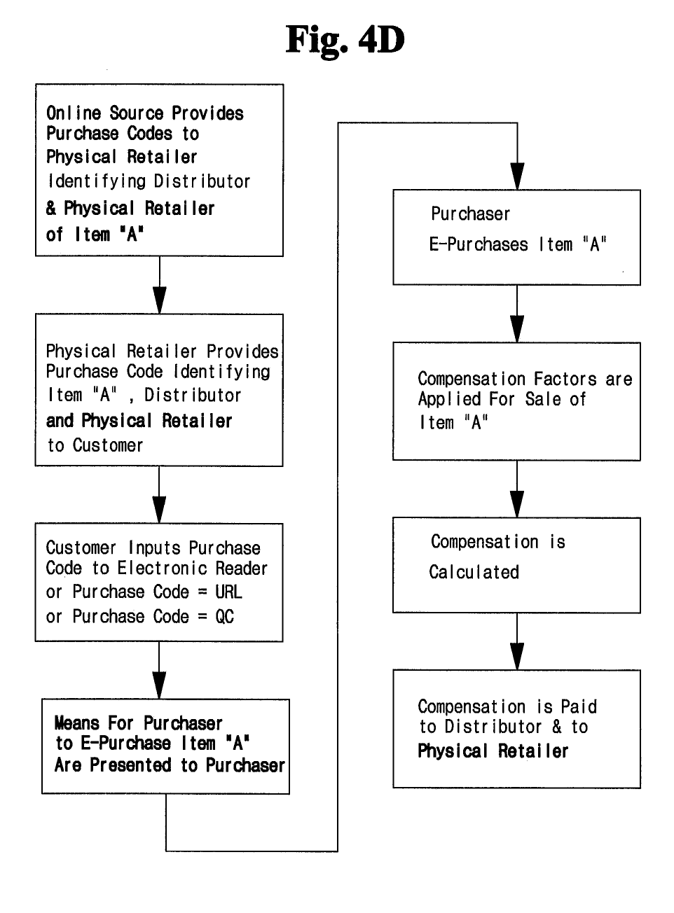

FIG. 4A Steps involved in a first embodiments of the computer-facilitated means to compensate a physical retailer for an on-line sale;

FIG. 4B More detailed depiction of the steps involved for an on-line sale;

FIG. 4C Steps involved to compensate a distributor for an on-line sale;

FIG. 4D Steps involved for an on-line sale to compensate both a physical retailer and a distributor.

### DETAILED DESCRIPTION OF THE INVENTION

The present invention comprises a system that provides means for a physical retailer to be compensated for its role in an on-line sale. The system includes an on-line retailer, a code and/or URL unique to a particular physical retailer, a compensation factor, and an on-line source having an on-line store or means to allow on-line purchases of the on-line source's goods. The on-line source assigns a unique code to the physical retailer which code is associated in the on-line source's system with the physical retailer. The physical retailer then distributes the unique code to its customers and/or potential customers. Use of the physical retailer's unique code associated with an on-line purchase from the on-line retailer triggers a commission payment to the physical retailer based on the compensation factor for that physical retailer. In short, the physical retailer refers the shopper to an on-line source and, if the shopper purchases from the on-line source and enters the code unique to the physical retailer or uses a URL unique to that physical retailer during the on-line purchasing process, the physical retailer is compensated for referring the shopper to the on-line source and the on-line retailer gains a customer it may otherwise not have had.

In practice, the physical retailer may provide the unique code and/or URL to the shopper in any of several ways; via coupon, card, or electronic advertising, newsletters, preferred customer programs, or electronically via geo-location tag. The unique code/URL may be provided with or without purchase from the physical retailer, The unique code/URL may have an expiration date and become inoperable after that date; alternatively, the unique code may be re-usable by the consumer or may be a limited one-time use. In one embodiment, the unique code is printed on a card along with the on-line source's identity and, perhaps, a description of what the on-line source offers for products; this card is provided to customers that purchase a certain type of product from the physical retailer. Or, perhaps, to those who purchase any type of product. The code may be, but is not required to be, a URL. It may be a bar code usable with QR technology or any other code or indicator that provides a bridge between its physical form and an online location. The shopper uses the code to route to an on-line site which may include but is not limited to opening a browser and entering the URL which takes the user to the web address and, from there is directed to or linked to, or automatically forwarded to the on-line store of the on-line source or one of its associates. In one embodiment, the bar code/QR/URL is unique to a particular physical good so that upon use of the code the shopper is presented with that particular good or, simply, with means to make an online purchase of that particular good. If the shopper purchases from the on-line store, a processor determines whether the purchase was associated with the unique code or URL, applies the compensation factor associated with the code and/or URL, and compensates an account of the physical retailer accordingly.

It is expected that the system will work especially well if the on-line retailer and the physical retailer sell products or services that complement one another. For example a fabric store (physical) and a digital sewing pattern provider (on-line) or a cookware store (physical) and a digital recipe or digital cooking demonstration provider (on-line) or a bookstore (physical) and an on-line source for audio books or ebooks. In one example, the shopper visits a fabric store. While at the physical store the shopper browses through a selection of sewing patterns and fabrics. The shopper purchases the fabric and other supplies necessary for sewing an item described by the sewing pattern and the physical retailer provides to the purchaser a URL, bar code, QR code (which may also be referred to herein as “QC”) or other online identifier specific to the sewing pattern and an online source of the sewing pattern. The shopper then enters the URL, bar code, QR code online either via browser or reader or other means that takes the shopper directly to a site, preferably to the specific page where the sewing pattern may be electronically purchased. Upon purchase, the aforementioned compensation factor is applied to account for compensation owed for the sale to the physical retailer.

Alternatively, the system comprises means to collect the unique code from the consumer upon purchase and then assigns appropriate credit to the physical retailer. Most often the compensated transaction takes place via an on-line store belonging to the on-line source or another on-line shopping tool on which the on-line source's goods are made available for sale. An on-line store comprises means for a shopper to purchase a selected product. Typically, consumers find a product of interest and visit the website of a retailer of that product directly or by searching among alternative vendors using a shopping search engine. Most online retailers use shopping cart software to allow the consumer to accumulate multiple items and to adjust quantities. A “checkout” process follows to facilitate payment and delivery. In today's online shopping world, online shoppers commonly use one of a several methods to effect payment, including but not limited to: credit card, online account, billing to mobile phones and landlines, debit card, direct debit in some countries, electronic money of various types, gift cards, etc. Once a payment has been accepted, the goods or services can be delivered in a number of ways including shipping to a customer-designated address via the public postal system or a retail courier such as FedEx, UPS, DHL, or TNT or drop shipping where the order is passed to the manufacturer or third-party distributor, who then ships the item directly to the consumer, bypassing the retailer' physical location to save time, money, and space or in-store pick-up. If the purchased product is a digital item it may be delivered via download; if the item is a ticket then printing of that ticket, or emailing the ticket may be used.

On-line payment with credit cards include validation of the card, movement of the money for payment to a merchant account of the vendor, generation and delivery of receipt data, followed by transfer of the payment to the vendor's regular bank account.

On-line shopping in this context is meant to include any sale that is facilitated on-line by an on-line store or any application that allows a user to purchase an item. According to the present invention, the consumer uses the URL or QR code to access the purchasing site or application. The URL/code comprises information that is specific to the on-line retailer and is associated with the specific item (e.g. sewing pattern) such that, upon use, the purchaser is directed to the on-line retailer's store or other source or address where that specified good (e.g., sewing pattern) is electronically offered for sale and may be purchased. In one embodiment, once the consumer purchases the specified item, the consumer may continue shopping for additional items or may elect to check out. In another embodiment, only the specified good may be purchased. Upon check out, the system queries the consumer as to whether it has a unique code and provides means for entry of the code to be recorded. The consumer enters the code and completes check-out and purchase. Alternatively, the unique code may comprise a URL or be comprised in a URL, and/or may comprise a code that works with QR technology or any code that works to uniquely identify the good and/or the site at which the good may be purchased. The URL may be linked by the on-line source to its online store. Purchases made via that URL will be credited to the physical retailer with which the on-line source associates that unique code or URL. The specified good may be an item that is electronically delivered or, alternatively, may be a physical item delivered by other means.

In one embodiment, the system simply records the entry of the URL or QR code associated with a particular retailer and an operator credits an account of the physical retailer when a sale is made in connection with that URL or QR code, In another embodiment, the system periodically surveys the data to determine the sales level associated with that retailer's unique code or URL, applies the compensation factor, and generates a report of compensation owed the physical retailer. Alternatively, an operator can implement these queries. In another embodiment, the system includes deposit information for an account belonging to the physical retailer and auto-pays the retailer according to associated sales. Or, the system periodically determines the revenue generated by a particular physical retailer over a period of time, withdraws that amount from an account of the on-line retailer and transfers it to an account of the physical retailer, and adjusts the payment records accordingly.

In a final embodiment, a distributor receives compensation for the designated sale rather than a physical retailer; optionally, the distributor may then compensate the retailer. Here, the use of the URL or QC or other code still takes the user to a specific site and is tied to a specific good and to the distributor of the good. Upon purchase, this embodiment applies a compensation factor and remits to the distributor. The URL or QC may also include information identifying the retailer from which the code was sourced. In this case, the distributor may then employ the unique code associated with the retailer to compensate the retailer. Alternatively, the code may include information dictating a compensation factor for the retailer and for the distributor such that, upon purchase, the compensation factors are both applied and compensation is accordingly remitted to the retailer and the distributor.

What I claim is:

1. A web-facilitated means for an on-line source to compensate a retailer for driving sales to an on-line store associated with said on-line source, said means comprising said on-line source assigning a unique identifier to said retailer, detecting the use of said unique identifier in relation to an on-line sale through the on-line store, and compensating the retailer for said on-line sale.

2. The web-facilitated means of claim 1, said on-line source comprising an on-line retailer.

3. The web-facilitated means of claim 1, said on-line source comprising a distributor.

4. The web-facilitated means of claim 1 wherein said unique identifier comprises a URL.

5. The web-facilitated means wherein said unique identifier comprises a QR code.

6. The means of claim 1 wherein said retailer comprises a physical retailer.

7. The means of claim 1 wherein compensating the retailer comprises applying a compensation factor.

8. The means of claim 1 wherein assigning a unique identifier comprises providing a plurality of physical cards bearing said identifier.

9. The means of claim 1 further comprising determining an amount of compensation owed said retailer and transferring the amount to an account assigned to said retailer.

10. The means of claim 1 said compensation factor consisting of one of a group consisting of flat rate, sales volume, or a pre-set minimum.

11. The web facilitated means of claim 1 said unique identifier conveyed by Near Field Communication to a potential consumer and detected in relation to said on-line sale.

12. A web-facilitated means for an on-line source to compensate a retailer for driving sales to an on-line store, said means comprising a processor to identify a unique identifier associated with said retailer and a sale at said on-line store apply a compensation factor and determining compensation to be paid the retailer based on said salethereafter causing an account of said retailer to be credited with said compensation.

13. The web-facilitated means of claim 12 wherein an on-line store comprises means to present a plurality of goods for sale along with information related to each said good.

14. The web-facilitated means of claim 13 wherein said on-line store further comprises means to allow a purchaser to select, purchase and pay for at least one of said plurality of goods.

15. The web-facilitated means of claim 12 wherein the unique identifier comprises a QR code.

16. The web-facilitated means of claim 12, wherein said compensation factor comprises a flat rate.

17. A web-facilitated system comprising an on-line purchasing site, a unique machine-readable code identifying a physical retailer and a particular good, and at least one processor programmed for identifying and accepting said unique code, translating the code to an order for said particular good, and applying a compensation factor to determine compensation owed said physical retailer.
